(19) United States
(12) Patent Application Publication
(10) Pub. No.: US 2006/0146875 A1
(43) Pub. Date: Jul. 6, 2006

(54) Media access controller and methods for distributed hop-by-hop flow control in wireless mesh networks

(76) Inventor: Luiyang Lily Yang, Portland, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/030,603

(22) Filed: Jan. 4, 2005

(51) Int. Cl. H04H 1/04

(52) U.S. Cl. 370/468

(57) ABSTRACT

A media access control layer of a wireless mesh network router includes a rate monitor to compare a packet transmission rate with a packet reception rate, and a rate adjustment request generator to generate a rate adjustment request message for one or more upstream neighbor nodes after the packet reception rate exceeds the packet transmission rate.

### TECHNICAL FIELD

Embodiments of the present invention pertain to wireless communications. Some embodiments of the present invention relate to mesh networks, and some embodiments relate to media access control.

### BACKGROUND

Wireless mesh networks, including digital home networks, may include several wireless communication nodes that transfer and route communications for different applications therebetween. One problem with conventional mesh networks is congestion. Congestion may result from upstream nodes sending more packets than downstream nodes can handle.

### BRIEF DESCRIPTION OF THE DRAWINGS

FIG. 1 illustrates a wireless mesh network in accordance with some embodiments of the present invention;

FIG. 2 is a block diagram of a wireless mesh network router in accordance with some embodiments of the present invention;

FIGS. 3A and 3B illustrate examples of congestion in a simplified wireless mesh network;

FIG. 4A is a flow chart of flow control management procedure in accordance with some embodiments of the present invention; and

FIG. 4B is a flow chart of rate adjustment procedure in accordance with some embodiments of the present invention.

### DETAILED DESCRIPTION

The following description and the drawings illustrate specific embodiments of the invention sufficiently to enable those skilled in the art to practice them. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. Embodiments of the invention set forth in the claims encompass all available equivalents of those claims. Embodiments of the invention may be referred to, individually or collectively, herein by the term “invention” merely for convenience and without intending to voluntarily limit the scope of this application to any single invention or inventive concept if more than one is in fact disclosed.

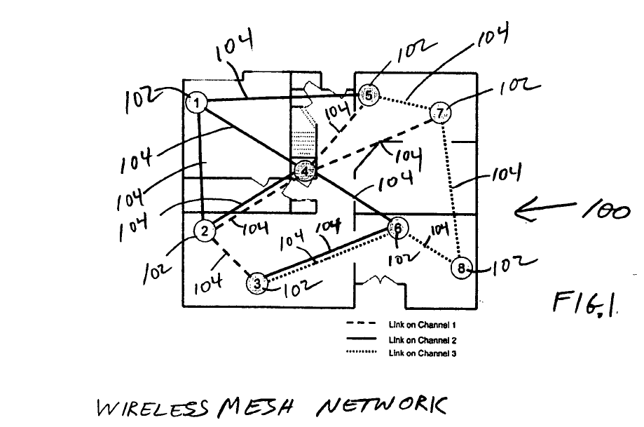

FIG. 1 illustrates a wireless mesh network in accordance with some embodiments of the present invention. Wireless mesh network 100 may comprise a plurality of wireless communication nodes 102 that may communicate with each other over one or more wireless communication channels 104. In some embodiments, at least some of wireless communication nodes 102 communicate with other nodes 102 using more than one wireless communication channel 104. In some embodiments, some wireless communication nodes 102 communicate with other nodes 102 using only one communication channel. Although wireless mesh network 100 is illustrated as a multichannel mesh network, the scope of the invention is not limited in this respect. In wireless mesh network 100, nodes 102 may contend for the shared resources of one or more of wireless communication channels 104.

In accordance with some embodiments of the present invention, nodes 102 may implement hop-by-hop flow control to help reduce congestion within network 100. In some embodiments, hop-by-hop flow control may be implemented at the media access control (MAC) layer and may include providing explicit signaling to upstream nodes to reduce transmissions. In some embodiments, a prior hop (i.e., upstream) neighbor node may be asked to reduce transmissions for a particular application flow. These embodiments are described in more detail below.

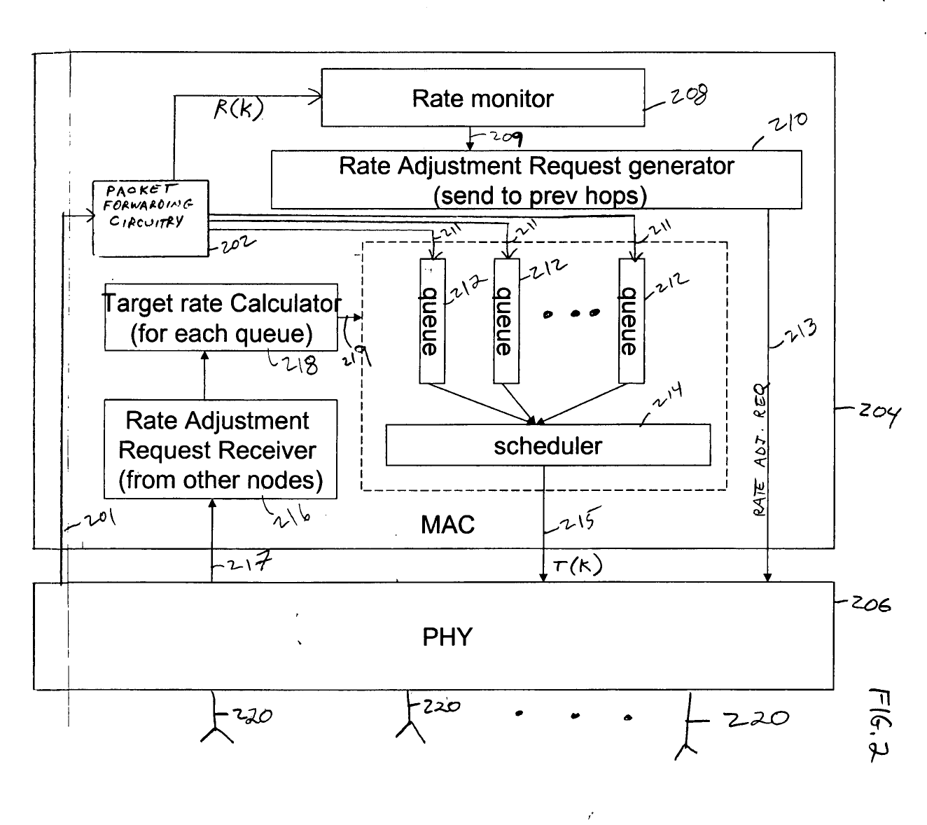

FIG. 2 is a block diagram of a wireless mesh network router in accordance with some embodiments of the present invention. Wireless mesh network router 200 may be suitable for use as one of nodes 102 of wireless mesh network 100 (FIG. 1), although other configurations may also be suitable. Wireless mesh network router 200 may implement flow control to reduce congestion in a wireless mesh network.

Wireless mesh network router 200 may comprise physical layer (PHY) 206 to communicate radio-frequency (RF) signals with one or more other nodes using one or more of antennas 220. Wireless mesh network router 200 may also comprise media access controller (MAC) 204 which may receive packets 201 for forwarding to other nodes from physical layer 206. Media access controller 204 may also provide MAC layer packets 215 to physical layer 206 for transmission to one or more other nodes of a wireless mesh network.

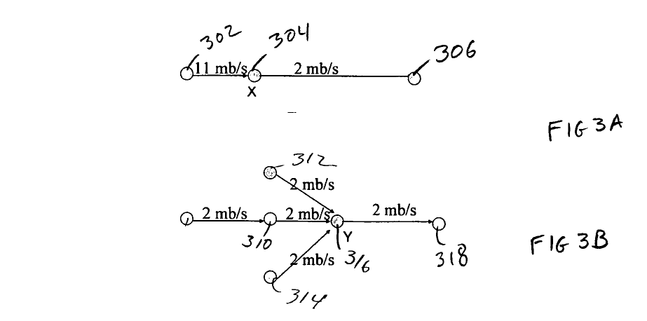

FIGS. 3A and 3B illustrate examples of congestion in a simplified wireless mesh network. In the example of FIG. 3A, congestion results at node 304 when node 304 is receiving packets at a rate of 11 mega-bits per second (MBPS) from node 302 while transmitting to node 306 at a rate of 2 MBPS. As illustrated, congestion may result in a wireless mesh network due to the multi-rate capability of the nodes. Without flow control, node 302, for example, may transmit whenever it can access the channel.

In the example of FIG. 3B, congestion may result at node 316 because nodes 310, 312 and 314 are transmitting at rates of 2 MPBS while node 316 is transmitting to node 318 at the rate of 2 MBPS. Node 316 may receive different application flows from nodes 310, 312 and 314 and may transmit all three of the application flows to node 318. In this situation, node 316 may be a bottleneck node due to the multiple flows. As illustrated in FIG. 3B, congestion may result in a wireless mesh network even when nodes transmit at the same rate.

Referring to FIG. 2, in accordance with some embodiments of the present invention, media access controller 204 may comprise rate monitor 208 to compare a packet transmission rate with a packet reception rate, and rate adjustment request generator 210 to generate a rate adjustment request message for one or more upstream neighbor nodes after the packet reception rate exceeds the packet transmission rate. In some embodiments, rate monitor 208 may compare a MAC layer packet transmission rate of MAC layer packets 215 with a MAC layer packet reception rate of MAC layer packets 211 for a plurality of service flows. In some embodiments, rate adjustment request generator 210 may be responsive to rate monitor 208 and may generate rate adjustment request message 213 for transmission to one or more upstream neighbor nodes that are transmitting received packets 201 after the MAC layer packet reception rate exceeds the MAC layer packet transmission rate.

In some embodiments, media access controller 204 may be part of wireless mesh network router 200 and may operate as a current node in a wireless mesh network (100), although the scope of the invention is not limited in this respect. In some embodiments, the current node (i.e., the node at which the packet reception rate exceeds the packet transmission rate) may generate the target transmission rate for the upstream neighbor nodes. In these embodiments, rate adjustment request generator 210 may calculate a recommended (i.e., target) transmission rate and rate adjustment request message 213 may be generated to include the recommended transmission rate. In these embodiments, the one or more upstream neighbor nodes may reduce their media access control layer packet transmissions to the current node based on the recommended transmission rate. In some embodiments, the recommended transmission rate may be calculated by rate adjustment request generator 210 of the current node to proportionally reduce all transmissions to the current node, although the scope of the invention is not limited in this respect. In some of these embodiments, each upstream neighbor node may proportionally reduce its packet transmissions to the current node.

In some alternate embodiments, the transmitting node (rather than the current node) may calculate the target transmission rate. In these embodiments, rate adjustment request generator 210 may calculate a ratio F(k) of the packet transmission rate T(k) to the packet reception rate R(k), and rate adjustment request message 213 may be generated to include the calculated ratio F(k). One or more upstream neighbor nodes of the network may calculate a new media access control layer packet transmission rate for packets to the current node based on the ratio received in rate adjustment request message 213. In some embodiments, the new transmission rate calculated by an upstream neighbor node may proportionally reduce transmissions to the current node. Each upstream neighbor node may proportionally reduce its packet transmissions to the current node, although the scope of the invention is not limited in this respect. In some embodiments, rate adjustment request generator 210 may generate rate adjustment request message 213 after the packet reception rate of packets 211 exceeds the packet transmission rate of packets 215 by a predetermined amount (e.g., a percentage) for a predetermined period of time.

In some embodiments, media access controller 204 may include scheduler 214 and a plurality of queues 212 to buffer packets prior to subsequent scheduling for transmission by scheduler 214. In these embodiments, rate monitor 208 may compare the packet transmission rate of packets 215 provided by scheduler 214 with the packet reception rate of packets 211 received by queues 212. When the packet reception rate of packets 211 exceeds the packet transmission rate of packets 215 by a predetermined amount (e.g., a percentage) for a predetermined period of time, this may indicate that at least some of queues 212 may be getting fuller. In some embodiments, rate monitor 208 may determine the packet reception rate of packets 211 and the packet transmission rate of packets 215 by determining when the queues 212 exceed a predetermine threshold (e.g., queues 212 become to full).

In some embodiments, wireless mesh network router 200 may further comprise packet forwarding circuitry 202 to receive packets 201 from physical layer 206 for forwarding to other nodes of the network. Packet forwarding circuitry 204 may provide packets 211 for an associated service flow to one or more of queues 212. Physical layer 206 may receive packets 215 from scheduler 214 for transmission to next-hop neighbor nodes of the network. In some embodiments, packets 201 received for forwarding may be associated with a service flow and may be received from the one or more upstream neighbor nodes of the network.

In some embodiments, the current node may be responsive to a rate adjustment request received from a next hop neighbor node. In these embodiments, media access controller 204 may include rate adjustment request receiver 216 to receive rate adjustment request message 217 from the next-hop neighbor node. In these embodiments, scheduler 214 may adjust the rate of packet transmissions of packets 215 to the next-hop neighbor node based on rate adjustment request message 217. In some of these embodiments, media access controller 204 may also include target rate calculator 216 to calculate target transmission rate 219 for subsequent media access control layer packet transmissions to the next-hop neighbor node. In some embodiments, scheduler 214 may be responsive to target transmission rate 219.

In some embodiments, rate adjustment request message 217 may be associated with one of a plurality of service flows (e.g., going to one next-hop neighbor node). The next-hop neighbor node may be configured to receive packets from the current node for the associated service flow and may generate rate adjustment request message 217 for the current node. In some embodiments, queues 212 may be each associated with one of the service flows and may buffer packets 211 of their associated service flow. Scheduler 214 may reduce the scheduling of packets from one of queues 212 associated with the service flow that is associated with rate reduction request message 217.

In some embodiments, the flows communicated between nodes of mesh network 100 (FIG. 1) may comprise multimedia and higher quality-of-service level (QoS) application flows including one or more of a voice (VO) application flow or a video (VI) application flow. Examples of multimedia and higher QoS level flows may include application flows such as a high-definition television (HDTV) application flow, a standard television (SDTV) application flow, a streaming video application flow and a voice application flow. In some embodiments, the flows communicated between nodes of mesh network 100 (FIG. 1) may also comprise lower quality-of-service level application flows including background (BK) and best effort (BE) application flows, such as an email application flow, an Internet application flow, a file transfer protocol (FTP) application flow, a transmission control protocol (TCP) application flow and a universal datagram protocol (UDP) application flow, although the scope of the invention is not limited in this respect. In some embodiments, media access controller 204 (FIG. 2) may perform an access control procedure, such as an enhanced distributed coordinated access (EDCA) procedure, to access a wireless communication channel (i.e., the transmission medium), although the scope of the invention is not limited in this respect.

In some embodiments, physical layer 206 may transmit multicarrier communication signals, such as orthogonal frequency division multiplexed (OFDM) communication signals, over communication channels 104 (FIG. 1). In some embodiments, the multicarrier communication signals may comprise a plurality of orthogonal subcarriers. In some embodiments, the orthogonal subcarriers may be closely spaced OFDM subcarriers. To help achieve orthogonality between the closely spaced subcarriers, each subcarrier may have a null at substantially a center frequency of the other subcarriers, although the scope of the invention is not limited in this respect. In some embodiments, to help achieve orthogonality between the closely spaced subcarriers, each subcarrier may have an integer number of cycles within a symbol period, although the scope of the invention is not limited in this respect.

In some embodiments, physical layer 206 may transmit and/or receive RF communications in accordance with specific communication standards, such as the Institute of Electrical and Electronics Engineers (IEEE) standards including IEEE 802.11(a), 802.11(b), 802.11(g/h) and/or 802.11(n) standards for wireless local area networks (WLANs) and/or the IEEE 802.11(s) and IEEE 802.11(e) standards for wireless mesh networks, although physical layer 206 may also be suitable to transmit and/or receive communications in accordance with other techniques.

In some embodiments, the frequency spectrums for communication channels 104 (FIG. 1) may comprise either a 5 GHz frequency spectrum or a 2.4 GHz frequency spectrum, although the scope of the invention is not limited in this respect. In these embodiments, the 5 GHz frequency spectrum may include frequencies ranging from approximately 4.9 to 5.9 GHz, and the 2.4 GHz spectrum may include frequencies ranging from approximately 2.3 to 2.5 GHz, although the scope of the invention is not limited in this respect, as other frequency spectrums are also equally suitable.

In some embodiments, wireless mesh network router 200 may be part of a wireless communication device, such as personal digital assistant (PDA), a laptop or portable computer with wireless communication capability, a web tablet, a wireless telephone, a wireless headset, a pager, an instant messaging device, a digital camera, an access point or other device that may receive and/or transmit information wirelessly.

Antennas 220 may comprise one or more directional or omnidirectional antennas, including, for example, dipole antennas, monopole antennas, patch antennas, loop antennas, microstrip antennas or other types of antennas suitable for reception and/or transmission of RF signals by physical layer 206.

Although router 200 is illustrated as having several separate functional elements, one or more of the functional elements may be combined and may be implemented by combinations of software-configured elements, such as processing elements including digital signal processors (DSPs), and/or other hardware elements. For example, processing elements may comprise one or more microprocessors, DSPs, application specific integrated circuits (ASICs), and combinations of various hardware and logic circuitry for performing at least the functions described herein. In some embodiments, the functional elements of router 200 may refer to one or more processes operating on one or more processing elements.

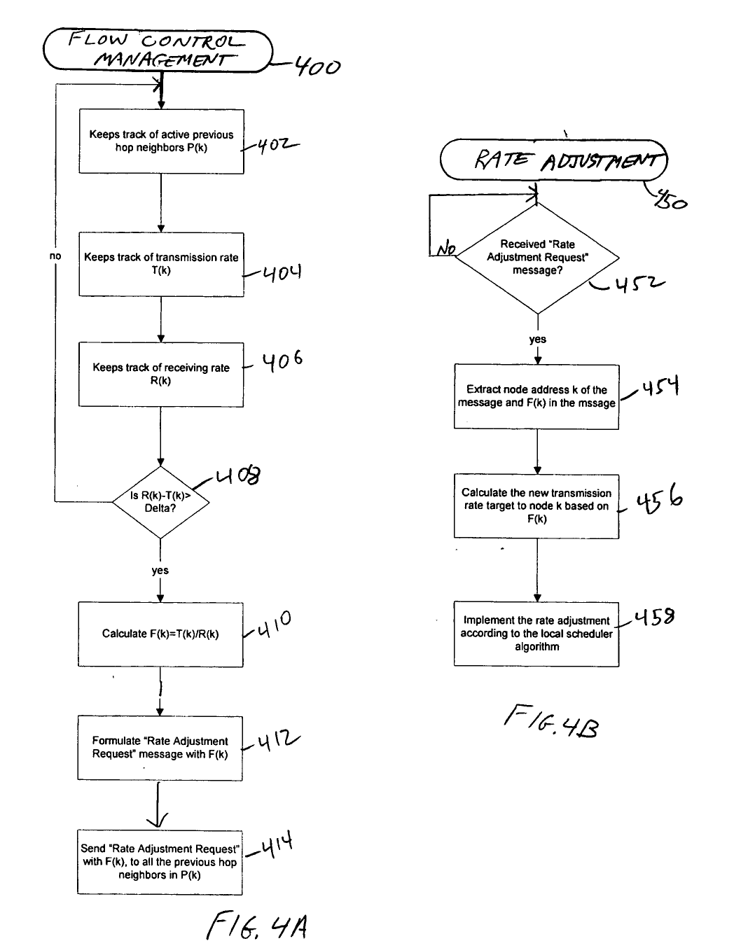

FIG. 4A is a flow chart of flow control management procedure in accordance with some embodiments of the present invention. Flow control management procedure 400 may be performed by one or more nodes of a wireless mesh network, such as network 100 (FIG. 1). In some embodiments, wireless mesh network router 200 (FIG. 2) may perform procedure 400, although other routers and devices may also perform procedure 400. In some embodiments, all nodes of a wireless mesh network perform procedure 400, although the scope of the invention is not limited in this respect.

Operation 402 comprises keeping track of active previous hop neighbors (e.g., upstream neighbor nodes currently transmitting to the current node). Operation 404 comprises monitoring the current node's MAC layer packet transmission rate T(k). Operation 406 comprises monitoring the current node's MAC layer packet reception rate R(k). In some embodiments, operations 402 through 406 may be performed by rate monitor 208 (FIG. 2), although the scope of the invention is not limited in this respect.

Operation 408 determines when the packet reception rate exceeds the packet transmission rate. If the packet reception rate does not exceed the packet transmission rate (e.g., at least for a predetermined period of time), operations 402 through 406 may be repeated. After the packet reception rate exceeds the packet transmission rate, operation 410 may be performed.

Operation 410 comprises generating a ratio F(k) based on the packet transmission rate T(k) and the packet reception rate R(k), and operation 412 comprises generating a rate adjustment request message that includes the ratio F(k). In some embodiments, operations 408 through 412 may be performed by rate adjustment request generator 210 (FIG. 2), although the scope of the invention is not limited in this respect.

Operation 414 comprises sending the rate adjustment request message to the previous hop neighbor nodes that are active (e.g., upstream neighbor nodes presently transmitting to the current node). The upstream neighbor nodes receiving the rate adjustment request message may respond by reducing their transmissions to the current node based on the ratio F(k). Operation 414 may be performed by physical layer 206 (FIG. 2), although the scope of the invention is not limited in this respect.

FIG. 4B is a flow chart of rate adjustment procedure in accordance with some embodiments of the present invention. Rate adjustment procedure 450 may be performed by one or more nodes of a wireless mesh network, such as network 100 (FIG. 1). In some embodiments, wireless mesh network router 200 (FIG. 2) may perform procedure 450, although other routers and devices may also perform procedure 450. In some embodiments, all nodes of a wireless mesh network perform procedure 450, although the scope of the invention is not limited in this respect. In some embodiments, procedure 450 may be performed by a node in response to receipt of a rate adjustment request message that may have been generated by the performance of procedure 400 (FIG. 4A) by another node. In some embodiments, procedure 450 may be performed by a MAC layer, such as media access controller 204 (FIG. 2).

Operation 452 comprises determining whether the current node performing procedure 450 has received a rate adjustment request message. After the message is received, operation 454 may be performed.

Operation 454 comprises extracting the address of the node sending the rate adjustment request message and verifying that the sending node is a next hop neighbor node. Operation 454 may also comprise verifying that the current node is currently sending packet transmissions (e.g., an application flow) to the next-hop neighbor node. When the sending node is a next-hop neighbor node and when the current node is currently sending packet transmission to the next-hop neighbor node, operation 456 is performed. In some embodiments, operations 452 and 454 may be performed by rate adjustment request receiver 216 (FIG. 2), although the scope of the invention is not limited in this respect.

Operation 456 comprises calculating a new (i.e., target) transmission rate for transmissions to the next-hop neighbor node based on a ratio F(k) received in the rate adjustment request message. In some embodiments, operation 456 may be performed by target rate calculator 218 (FIG. 2), although the scope of the invention is not limited in this respect.

Operation 458 comprises implementing the new packet transmission rate generated in operation 456 for the packet flow going to the associated next-hop neighbor node. In some embodiments, operation 458 may comprise reducing packet transmissions from one of queues 212 (FIG. 2) associated with the flow to the next hop neighbor node. Transmissions of packets to other next hop neighbor nodes are not necessarily affected.

Although the individual operations of procedures 400 and 450 are illustrated and described as separate operations, one or more of the individual operations may be performed concurrently, and nothing requires that the operations be performed in the order illustrated.

Referring to FIG. 4A, in some embodiments, operation 402 may comprise, for each node k, defining P(k) as the set of active previous hop neighbors. In some embodiments, operations 404 and 406 may comprise node k (i.e., the current node) monitoring its effective MAC transmission rate T(k) and reception rate R(k) and hence its backpressure Δₖ=R(k)−T(k) In some embodiments, procedures 400 and 450 (FIG. 4B) may be used to maintain the backpressure close to zero so that there is little or no local congestion at node k, although the scope of the invention is not limited in this respect.

After Δₖ is substantially above zero for a predetermined time period, R(k) may be reduced so that Δₖ can be brought back to near zero level. In some embodiments, because the reception rate of node k cannot be controlled directly, the reception rate may be controlled indirectly by reducing the data transmission rate of node i to node k for most or all nodes i∈P(k). In some embodiments, node k may assume that all the nodes in P(k) contributed to the congestion at k proportionally. In these embodiments, these upstream next neighbor nodes may be asked to reduce their transmission rate to node k proportionally so that collectively the nodes may reduce the backpressure at node k to a near zero level. In some embodiments, node i, as one of the nodes in P(k), may reduce its transmission rate to k proportionally so that the new transmission rate from node i to k may be

$${T}_{i , k}^{′} = {T}_{i , k} - {Δ}_{k} ⋆ \frac{{T}_{i , k}}{R ( k )} = {T}_{i , k} ( 1 - \frac{{Δ}_{k}}{R ( k )} ) = {T}_{i , k} * \frac{T ( k )}{R ( k )} = {T}_{i , k} F ( k ) ,$$

where T_{i,k} is the original transmission rate from node i to node k before the adjustment, and

$$F ( k ) = \frac{T ( k )}{R ( k )}$$

is the adjustment factor node i may use for its transmission rate adjustment. In some embodiments, the ratio F(k) may be a fractional number between zero and one.

To inform its previous hop neighbors in P(k) about the backpressure situation at node k so that they can adjust their transmission rate accordingly, in operation 414 node k may send an explicit signaling message to the nodes in P(k) with the adjustment factor F(k). In some embodiments, this explicit signaling message may be referred to as a rate adjustment request message.

Upon receiving a rate adjustment request message from node k, node i may perform operations 454 through 458 of procedure 450 (FIG. 4B) to reduce its MAC transmission rate in accordance with the following equation: T′_{i,k}=T_{i,k}*F(k), although the scope of the invention is not limited in this respect.

Reducing the MAC transmission rate from node i to node k does not necessarily require the modulation schemes implemented by physical layer 206 (FIG. 2) to reduce the transmission rate. In some embodiments, node i may adjust its effective MAC transmission rate by an internal scheduling algorithm performed by scheduler 214 (FIG. 2) that may purposely delay the transmission of packets from node i to node k. In some embodiments, a contention window may be increased to delay packet transmission, although the scope of the invention is not limited in this respect.

In some embodiments, a scheduler, such as scheduler 214 (FIG. 2) at node i, may employ one queue 212 (FIG. 2) per next hop neighbor. In this example, node i may have three active next hop neighbors (e.g., node k, node m and node n) and hence three queues 212 (FIG. 2) may be used. Packets to be transmitted from node i to node k may be placed in an associated queue Q(k). In some embodiments when multiple queues are present, scheduler 214 (FIG. 2) may determine when to take a packet from which queue. In some embodiments, a weighted round robin scheduler may be used, although the scope of the invention is not limited in this respect.

For example, the initial weight for the queues may be 1:1:1, meaning that the scheduler 214 (FIG. 2) takes a packet out of each queue 212 (FIG. 2) in a round robin fashion. When node i receives a rate adjustment request message from node k, with F(k)=0.5, the message may indicate by the ratio that node i should reduce its effective transmission rate to node k by half. In some embodiments, node i may respond to this request by adjusting the weight for the three queues from 1:1:1 to 1:2.5:2.5 (or, effectively, 2:5:5) so that for every 3 packets sent out from i, one of the packets is sent to node k. Therefore, the transmission rate from node i to node k may be effectively one third of the total link capacity (assuming traffic is at least slightly backlogged in the queues). Thus, by adjusting the weights in scheduler 214 (FIG. 2), a rate adjustment request from node k may be effectively realized.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices.

Embodiments of the invention may be implemented in one or a combination of hardware, firmware and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, electrical, optical, acoustical or other form of propagated signals (e.g., carrier waves, infrared signals, digital signals, etc.), and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims.

In the foregoing detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim. Rather, as the following claims reflect, invention may lie in less than all features of a single disclosed embodiment. Thus the following claims are hereby incorporated into the detailed description, with each claim standing on its own as a separate preferred embodiment.

What is claimed is:

1. A media access controller comprising:
a rate monitor to compare a packet transmission rate with a packet reception rate; and
a rate adjustment request generator to generate a rate adjustment request message for one or more upstream neighbor nodes in response to a comparison between the packet reception rate and the packet transmission rate.

2. The media access controller of claim 1 wherein the media access controller is part of a wireless mesh network router that operates as a current node in a wireless mesh network,
wherein the rate adjustment request generator is adapted to calculate a recommended transmission rate,
wherein the rate adjustment request message includes information related to the recommended transmission rate, and
wherein the one or more upstream neighbor nodes are other nodes of the network and are adapted to reduce their media access control layer packet transmissions to the current node based on the recommended transmission rate.

3. The media access controller of claim 2 wherein the recommended transmission rate is calculated by the rate adjustment request generator to proportionally reduce transmissions to the current node.

4. The media access controller of claim 1 wherein the media access controller is part of a wireless mesh network router that operates as a current node in a wireless mesh network,
wherein the rate adjustment request generator is adapted to calculate a ratio of the packet transmission rate to the packet reception rate,
wherein the rate adjustment request message includes the calculated ratio, and
wherein the one or more upstream neighbor nodes are other nodes of the network and are adapted to calculate a new media access control layer packet transmission rate for packets to the current node based on information related to the ratio received in the rate adjustment request message.

5. The media access controller of claim 4 wherein the new transmission rate is calculated by the one or more upstream neighbor nodes to proportionally reduce a rate of packet transmissions to the current node.

6. The media access controller of claim 1 wherein the rate adjustment request generator is adapted to generate the rate adjustment request message when the packet reception rate exceeds the packet transmission rate for a predetermined period of time.

7. The media access controller of claim 1 wherein the media access controller is part of a wireless mesh network router that operations as a current node in a wireless mesh network, and
wherein the media access controller further comprises:
a scheduler; and
a plurality of queues to buffer packets prior to subsequent scheduling for transmission by the scheduler,
wherein the rate monitor is adapted to compare the packet transmission rate of packets provided by the scheduler with the packet reception rate of packets received by the queues.

8. The media access controller of claim 7 wherein the rate monitor is further adapted to determine the packet reception rate and the packet transmission rate by determining when the queues exceed a predetermine threshold.

9. The media access controller of claim 7 wherein the wireless mesh network router comprises:
a physical layer; and
packet forwarding circuitry to receive packets from the physical layer for forwarding to other nodes of the network, the packet forwarding circuitry adapted to provide packets for an associated service flow to one of the queues,
wherein the physical layer is adapted to receive packets from the scheduler for transmission to next-hop neighbor nodes of the network, and
wherein the packets received for forwarding are associated with a service flow and are received from the one or more upstream neighbor nodes of the network.

10. The media access controller of claim 1 further comprising:
a rate adjustment request receiver to receive a rate adjustment request message from a next-hop neighbor node; and
a scheduler to adjust the rate of packet transmissions to the next-hop neighbor node based on the rate adjustment request message.

11. The media access controller of claim 10 further comprising a target rate calculator to calculate a target transmission rate for subsequent media access control layer packet transmissions to the next-hop neighbor node,
wherein the scheduler is responsive to the target transmission rate.

12. The media access controller of claim 10 wherein the media access controller is part of a wireless mesh network router that operates as a current node in a wireless mesh network,
wherein the rate adjustment request message is associated with one of a plurality of service flows,
wherein the next-hop neighbor node is another node of the network adapted to receive packets from the current node for the associated service flow and adapted to generate the rate adjustment request message for the current node.

13. The media access controller of claim 12 further comprising a plurality of queues, each queue being associated with one of the service flows,
wherein the queues buffer packets of their associated service flow,
wherein the scheduler is adapted to reduce the scheduling of packets from one of the queues associated with the service flow associated with the rate reduction request message, and
wherein the rate monitor determines the packet reception rate and the packet transmission rate by determining when the queues exceed a predetermine threshold.

14. A method comprising:
comparing a packet transmission rate with a packet reception rate at a current node in a wireless mesh network; and
generating a rate adjustment request message for one or more upstream neighbor nodes of the wireless mesh network after the packet reception rate exceeds the packet transmission rate.

15. The method of claim 14 further comprising:
calculating a recommended transmission rate at the current node; and
including information relating to the recommended transmission rate in the rate adjustment request message,
wherein the one or more upstream neighbor nodes reduce their media access control layer packet transmissions to the current node based on the recommended transmission rate.

16. The method of claim 15 wherein the recommended transmission rate is calculated to proportionally reduce transmissions to the current node.

17. The method of claim 14 further comprising:
calculating a ratio of the packet transmission rate to the packet reception rate; and
including information relating to the calculated ratio within the rate adjustment request message,
wherein the one or more upstream neighbor nodes calculate a new media access control layer packet transmission rate for packets to the current node based on the ratio received in the rate adjustment request message.

18. The method of claim 17 wherein the new transmission rate is calculated by the one or more upstream neighbor nodes to proportionally reduce transmissions to the current node.

19. The method of claim 14 wherein the rate adjustment request message is generated after the packet reception rate exceeds the packet transmission rate for a predetermined period of time.

20. The method of claim 14 further comprising buffering packets in queues prior to subsequent scheduling for transmission by a scheduler,
wherein comparing comprises comparing the packet transmission rate of packets provided by the scheduler with the packet reception rate of packets received by the queues.

21. The method of claim 20 wherein comparing comprises determining when the queues exceed a predetermine threshold.

22. The method of claim 20 further comprising:
receiving packets from a physical layer for forwarding to other nodes of the network;
providing packets for an associated service flow to one of the queues; and
receiving packets from the scheduler for transmission to next-hop neighbor nodes of the network,
wherein the packets received for forwarding are associated with a service flow and are received from the one or more upstream neighbor nodes of the network.

23. The method of claim 14 further comprising:
receiving a rate adjustment request message from a next-hop neighbor node; and
adjusting the rate of packet transmissions to the next-hop neighbor node based on the rate adjustment request message.

24. The method of claim 23 further comprising:
calculating a target transmission rate for subsequent media access control layer packet transmissions to the next-hop neighbor node; and
scheduling packets for transmission to the next-hop neighbor node in accordance with the target transmission rate.

25. The method of claim 23 wherein the rate adjustment request message is associated with one of a plurality of service flows, and
wherein the next-hop neighbor node is another node of the network adapted to receive packets from the current node for the associated service flow and adapted to generate the rate adjustment request message for the current node.

26. The method of claim 25 further comprising:
buffering packets in queues of an associated service flow; and
reducing the scheduling of packets from one of the queues associated with the service flow associated with the rate reduction request message.

27. A router for use as a node in a wireless mesh network comprising:
a media access controller; and
a physical layer transmit a rate adjustment request message to one or more upstream neighbor nodes of the network,
wherein the media access controller comprises:
a rate monitor to compare a packet transmission rate with a packet reception rate; and
a rate adjustment request generator to generate the rate adjustment request message after the packet reception rate exceeds the packet transmission rate.

28. The router of claim 27 wherein the router operates as a current node in the wireless mesh network,
wherein the rate adjustment request generator is adapted to calculate a recommended transmission rate,
wherein the rate adjustment request message includes information related to the recommended transmission rate,
wherein the one or more upstream neighbor nodes are other nodes of the network and are adapted to reduce their media access control layer packet transmissions to the current node based on the recommended transmission rate, and
wherein the recommended transmission rate is calculated by the rate adjustment request generator to proportionally reduce transmissions to the current node.

29. The router of claim 27 wherein the router operates as a current node in the wireless mesh network,
wherein the rate adjustment request generator is adapted to calculate a ratio of the packet transmission rate to the packet reception rate,
wherein the rate adjustment request message includes the calculated ratio,
wherein the one or more upstream neighbor nodes are other nodes of the network and are adapted to calculate a new media access control layer packet transmission rate for packets to the current node based on information related to the ratio received in the rate adjustment request message, and
wherein the new transmission rate is calculated by the one or more upstream neighbor nodes to proportionally reduce a transmission rate of transmissions to the current node.

30. The router of claim 27 wherein the router operates as a current node in the wireless mesh network, and
wherein the media access controller further comprises:
a scheduler; and
a plurality of queues to buffer packets prior to subsequent scheduling for transmission by the scheduler,
wherein the rate monitor is adapted to compare the packet transmission rate of packets provided by the scheduler with the packet reception rate of packets received by the queues, and
wherein the rate monitor is further adapted to determine the packet reception rate and the packet transmission rate by determining when the queues exceed a predetermine threshold.

31. The router of claim 30 further comprising:
a physical layer; and
packet forwarding circuitry to receive packets from the physical layer for forwarding to other nodes of the network, the packet forwarding circuitry adapted to provide packets for an associated service flow to one of the queues,
wherein the physical layer is adapted to receive packets from the scheduler for transmission to next-hop neighbor nodes of the network, and
wherein the packets received for forwarding are associated with a service flow and are received from the one or more upstream neighbor nodes of the network.

32. The router of claim 27 wherein the media access controller further comprises:
a rate adjustment request receiver to receive a rate adjustment request message from a next-hop neighbor node;
a scheduler to adjust the rate of packet transmissions to the next-hop neighbor node based on the rate adjustment request message; and
a target rate calculator to calculate a target transmission rate for subsequent media access control layer packet transmissions to the next-hop neighbor node,
wherein the scheduler is responsive to the target transmission rate.

33. The router of claim 32 wherein the router operates as a current node in the wireless mesh network,
wherein the rate adjustment request message is associated with one of a plurality of service flows,
wherein the next-hop neighbor node is another node of the network adapted to receive packets from the current node for the associated service flow and adapted to generate the rate adjustment request message for the current node,
wherein the media access controller further comprises a plurality of queues, each queue being associated with one of the service flows,
wherein the queues buffer packets of their associated service flow, and
wherein the scheduler is adapted to reduce the scheduling of packets from one of the queues associated with the service flow associated with the rate reduction request message.

34. A system comprising:
a substantially omnidirectional antenna; and
a router having a media access controller and a physical layer coupled to the antenna, the physical layer adapted to transmit a rate adjustment request message to one or more upstream neighbor nodes of a wireless mesh network,
wherein the media access controller of the router comprises:
a rate monitor to compare a packet transmission rate with a packet reception rate; and
a rate adjustment request generator to generate the rate adjustment request message after the packet reception rate exceeds the packet transmission rate.

35. The system of claim 34 wherein the router operates as a current node in the wireless mesh network,
wherein the rate adjustment request generator is adapted to calculate a recommended transmission rate,
wherein the rate adjustment request message includes information related to the recommended transmission rate,
wherein the one or more upstream neighbor nodes are other nodes of the network and are adapted to reduce their media access control layer packet transmissions to the current node based on the recommended transmission rate, and
wherein the recommended transmission rate is calculated by the rate adjustment request generator to proportionally reduce transmissions to the current node.

36. The system of claim 34 wherein the router operates as a current node in the wireless mesh network,
wherein the rate adjustment request generator is adapted to calculate a ratio of the packet transmission rate to the packet reception rate,
wherein the rate adjustment request message includes the calculated ratio,
wherein the one or more upstream neighbor nodes are other nodes of the network and are adapted to calculate a new media access control layer packet transmission rate for packets to the current node based on information related to the ratio received in the rate adjustment request message, and
wherein the new transmission rate is calculated by the one or more upstream neighbor nodes to proportionally reduce a transmission rate of transmissions to the current node.

37. A machine-accessible medium that provides instructions, which when accessed, cause a machine to perform operations comprising:
comparing a packet transmission rate with a packet reception rate at a current node in a wireless mesh network; and
generating a rate adjustment request message for one or more upstream neighbor nodes of the wireless mesh network after the packet reception rate exceeds the packet transmission rate.

38. The machine-accessible medium of claim 37 wherein the instructions, when further accessed cause the machine to perform operations further comprising:
calculating a recommended transmission rate at the current node; and
including information relating to the recommended transmission rate in the rate adjustment request message,
wherein the one or more upstream neighbor nodes reduce their media access control layer packet transmissions to the current node based on the recommended transmission rate, and
wherein the recommended transmission rate is calculated to proportionally reduce transmissions to the current node.

39. The machine-accessible medium of claim 37 wherein the instructions, when further accessed cause the machine to perform operations further comprising:
calculating a ratio of the packet transmission rate to the packet reception rate; and
including information relating to the calculated ratio within the rate adjustment request message,
wherein the one or more upstream neighbor nodes calculate a new media access control layer packet transmission rate for packets to the current node based on the ratio received in the rate adjustment request message, and
wherein the new transmission rate is calculated by the one or more upstream neighbor nodes to proportionally reduce transmissions to the current node.
